(19) United States
(12) Patent Application Publication
(10) Pub. No.: US 2024/0198972 A1
(43) Pub. Date: Jun. 20, 2024

(54) CLEANING SYSTEM OF A VEHICLE

(71) Applicant: Robert Bosch GmbH, Stuttgart (DE)

(72) Inventors: Adam Ugron, Budapest (HU); Alan Pfetzer, Buehl (DE); Alexander Dudek, Offenburg (DE); Anisha Saxena, Weinheim (DE); Godelieve Kraemer, Huegelsheim (DE)

(21) Appl. No.: 18/539,548

(22) Filed: Dec. 14, 2023

(30) Foreign Application Priority Data
Dec. 16, 2022 (DE) 10 2022 213 761.2

(51) Int. Cl. B60S 1/48; B60S 1/52; B60S 1/54

(52) U.S. Cl. CPC B60S 1/482; B60S 1/52; B60S 1/542

(57) ABSTRACT

A cleaning system of a vehicle, comprising: a first medium unit; an acceleration unit, a second medium unit, wherein the first medium unit is configured to direct a first medium into the acceleration unit, wherein the acceleration unit is configured to discharge the first medium from the cleaning system in a predetermined fluid flow, and wherein the second medium unit is configured to introduce a second medium into the predetermined fluid flow.

### BACKGROUND

The present invention relates to a cleaning system of a vehicle, a wiper system, and a vehicle.

There are currently a plurality of different solutions for cleaning surfaces in the vehicle area. Due to the increasing number of surfaces to be cleaned on the vehicle and their sensors, the demand for cleaning liquid kept in stock is continuously increasing.

Steady weight reduction in the vehicle area to reduce consumption and increasing competition create cost pressure so that cheaper and more efficient components for vehicles are more in demand.

### SUMMARY

The cleaning system of a vehicle according to the disclosure has the advantage over the known system that the consumption of cleaning liquids can be significantly reduced. Thus, the refilling frequency is reduced for the user of the vehicle. Further, the dissolution of dirt or the cleaning effect may be improved by the combination of two media. By combining the two media, the pressure of one or both media can also be lowered, which can lead to less wear on the cleaning system as well as less energy consumption of the cleaning system.

According to the present disclosure, this is achieved by the cleaning system of a vehicle comprising a first medium unit, an acceleration unit, and a second medium unit. The first medium unit is configured to direct a first medium, in particular a cleaning agent, into the acceleration unit, wherein the acceleration unit is configured to discharge the first medium from the cleaning system in a predetermined fluid flow. Further, the second medium unit is configured to introduce a second medium, in particular a pressurized gas, into the predetermined fluid flow.

In other words, the cleaning system of a vehicle is in particular a cleaning system that is arranged near a surface to be cleaned or is arranged in or on a wiper that cleans the surface to be cleaned. The first medium unit may preferably comprise a connection to a fluid system connecting the first medium unit to a pump, a compressor, or a tank. Further, the first medium unit may comprise a pump or compressor for conveying a first medium, such as a cleaning agent. Preferably, the first medium unit comprises a cavity in which the first medium can be distributed. The first medium unit may be connected to the acceleration unit or both may have a one piece design. Further, the first medium unit may be fluidly connected to the acceleration unit. The acceleration unit preferably comprises an acceleration channel which forms a predetermined fluid flow. Preferably, the predetermined fluid flow may be formed from the first medium and/or the second medium. Preferably, the first medium is a liquid and the second medium is a gas. Further, the first medium may be a gas and the second medium may be a liquid. Liquids include liquid mixtures also with solids. Further, the first medium may be a first fluid and the second medium may be a second fluid. Further, the predetermined fluid flow may be configured to clean a surface to be cleaned. The predetermined fluid flow can be specifically adjusted by means of the contour or design of the acceleration channel. Further, the acceleration channel may form a nozzle which changes the material properties of the first medium, e.g., atomizes it. Preferably, the acceleration unit and the second medium unit are connected to each other when configured in multiple pieces or they may have a one piece design. Preferably, the first medium and the second medium are separated from each other until the first medium exits the acceleration unit and until the second medium exits the second medium unit. Only when the first medium exits the acceleration unit and the second medium exits the second medium unit are the first medium and the second medium preferably mixed together or the second medium is introduced into the first medium. The second medium unit may comprise a connection to a pump, compressor, and/or tank which provides the second medium. The second medium unit may comprise a cavity receiving the second medium. Further, the second unit of medium preferably comprises an opening through which the second medium is introduced into the predetermined fluid flow.

Preferably, the cleaning system comprises a control unit, wherein the control unit is configured to control a fluid flow of the first medium and a fluid flow of the second medium.

An advantage of this embodiment may be that, using the control unit, the pressure, quantity, and type of media can be specifically adjusted. Thus, for example, in the case of a dusty surface, only the second medium, for example air, may be activated, so that the first medium, for example cleaning agent, may also be saved. Preferably, the control unit may be a separate component for controlling the cleaning system or may also be fully or partially integrated into another logic system. The control unit is preferably connected to actuators, which can adjust a flow rate of a fluid flow of the first medium or the second medium. The control unit can selectively control the first medium flow and/or the second medium flow. Preferably, the medium flow is the amount per time of a medium flowing through a channel.

Preferably, the control unit is configured to control the fluid flow of the first medium and/or the fluid flow of the second medium based on a switching sequence.

An advantage of this embodiment may be that the control unit or a sensor detects the type of soiling on the surface to be cleaned and thus an optimized switching sequence can be selected to further improve the efficiency of the cleaning system. Preferably, the switching sequence controls an activity of the fluid flow of the first medium as well as the fluid flow of the second medium. Further, the switching sequence may comprise a sequence and/or a quantity of the fluid flow of the first or second mediums respectively.

Preferably, the switching sequence comprises a simultaneous fluid flow of the first medium and the second medium, followed by a fluid flow of the second medium alone. Further preferably, the first medium may be gaseous and the second medium may be liquid, thereby the switching sequence may be inverted.

An advantage of this embodiment may be that soiling is softened with the aid of the simultaneous fluid flow of the first and second medium and subsequently the softened soiling is blown away by means of the second medium, e.g., air, such that the amount of first medium, e.g., cleaning agent, is reduced. Preferably, the fluid flow of the first and/or second medium may be controlled sequentially, using a switching sequence or pattern by means of the control unit. The switching sequence can be adjusted, for example, to a type and/or amount of soiling.

Preferably, the control unit is configured to control a pressure and/or a flow rate of the first medium and/or the second medium.

An advantage of this embodiment may be that by means of the targeted control of the pressure or the flow rate, the mixing of the first and second medium can be adjusted and thus the cleaning efficiency can be further increased. Preferably, the cleaning system may comprise a first control valve for the fluid flow of the first medium. Further, the cleaning system may comprise a second control valve for the fluid flow of the second medium. Particularly preferably, the cleaning system comprises at least one return flow protection for the first and/or second medium. Preferably, in the event of stubborn soiling, the pressure of the first and/or second medium may be increased.

Preferably, the control unit is configured to set a quantity ratio between the first medium and the second medium.

An advantage of this embodiment may be that, depending on the ambient conditions, cleaning can be adjusted to thus reduce the consumption of the first medium, for example cleaning agent.

Preferably, the fluid flow of the first medium passes at least partially through the first medium unit and the fluid flow of the second medium passes at least partially through the second medium unit, wherein the fluid flow of the first medium and the fluid flow of the second medium are arranged substantially orthogonal to a flow direction of the predetermined fluid flow.

An advantage of this embodiment may be that the construction height of the cleaning system is reduced as the connections of the first medium and the second medium can be laterally mounted. Thus, new use scenarios for the cleaning system can preferably be developed. Preferably, the fluid flow of the first medium and the second medium is oriented at least in part on the basis of a direction, and the predetermined fluid flow is arranged substantially orthogonal to the direction of the first and second medium. This essentially means a deviation of +/−20°.

Preferably a gap is arranged between the acceleration unit and the second medium unit, wherein the second medium unit directs the second medium through the gap to increase a flow rate of the first medium.

An advantage of this embodiment may be that the pressure of the first medium can be reduced in order to, for example, protect a pump or to prevent cavities. Further, the gap in combination with the strict separation of the first medium from the second medium can prevent a return flow of the first medium, e.g., cleaning agent, into the one channel of the second medium, as the two media are only mixed when they exit the cleaning system.

Preferably, the acceleration unit comprises a first tear-off edge, wherein the second medium unit has a second tear-off edge, wherein the first tear-off edge and the second tear-off edge lie preferably in one plane.

An advantage of this embodiment may be that by matching the tear-off edges to each other, a particularly laminar air flow can be created so that the effectiveness of the cleaning system can be further improved. Preferably, the tear-off edge of the first acceleration unit and the tear-off edge of the second medium are arranged on a plane such that the first tear-off edge and the second tear-off edge are at one height.

Further preferably, the first tear-off edge is arranged offset from the second tear-off edge.

Preferably, the cleaning system comprises a nozzle unit, wherein the nozzle unit is configured to atomize the predetermined fluid flow.

An advantage of this embodiment may be that by means of the atomization of the predetermined fluid flow, the cleaning effect of the cleaning system may be further improved, as the atomization of the first medium may increase its surface area and thus absorb more dirt particles. Preferably, by means of the nozzle unit, the second medium may be introduced into the predetermined fluid flow so that the first medium is broken up. For example, a water-based cleaning agent may be atomized as the first medium by means of an air flow as the second medium. The nozzle unit can in particular be attached to the second medium unit and/or be made in one piece with it.

Preferably, the nozzle unit comprises at least one actuator, wherein the actuator is configured to alter an orientation of the predetermined fluid flow.

An advantage of this embodiment may be that by means of the actuator, the predetermined fluid flow can be adjusted to a soiling of the surface to be cleaned. Thus, the efficiency of the cleaning system may be further improved. Preferably, an actuator is any system that converts an electrical signal into a mechanical movement. For example, the actuator is hydraulically, pneumatically, or electrically powered. The actuator may adjust the orientation and/or the diameter or the spray shape of the nozzle unit.

Preferably, the first medium unit, the acceleration unit, and the second medium unit can have a one piece or multi-part design.

An advantage of this embodiment may be that the respective design can be adapted to a respective manufacturing process in order to improve the cost efficiency of the cleaning system. For example, an additive manufacturing process such as 3D printing can be selected for a one-piece design of the first medium unit, the acceleration unit, and the second medium unit. In a multi-part design of the first medium unit, the acceleration unit, and the second medium unit, injection molding may be used. In a multi-part embodiment, corresponding sealing means may be provided between the components.

Preferably, the cleaning system comprises at least one pump and/or at least one compressor, wherein the pump and/or the compressor are configured to compress the first medium and/or the second medium.

An advantage of this embodiment may be that the compression of the first and second medium can be specifically adjusted in order to thus further reduce consumption of the liquid cleaning agent. Preferably, a pump is provided for the first medium, in particular a water-based cleaning agent, and a compressor is provided for the second medium, in particular ambient air.

Another aspect of the invention relates to a wiper system comprising a wiper unit for windshields, sensors, in particular lidar and/or camera sensors, mirrors and/or headlights, and a cleaning system as described above and below.

An advantage of this embodiment may be that the cleaning system and in particular the media flows of the first and second medium can be adapted to the wiper unit and the surface being cleaned.

Another aspect of the invention relates to a vehicle comprising a cleaning system as described above and below. A vehicle may be a car, a van, a truck, a bus, or two- or three-wheeled vehicles having ADAS.

### BRIEF DESCRIPTION OF THE DRAWINGS

Exemplary embodiments of the invention are described in detail in the following with reference to the accompanying drawing. The drawing shows:

FIG. 1 shows a cleaning system according to one embodiment,

FIG. 2 shows a wiper system according to one embodiment, and

FIG. 3 shows a vehicle according to one embodiment.

### DETAILED DESCRIPTION

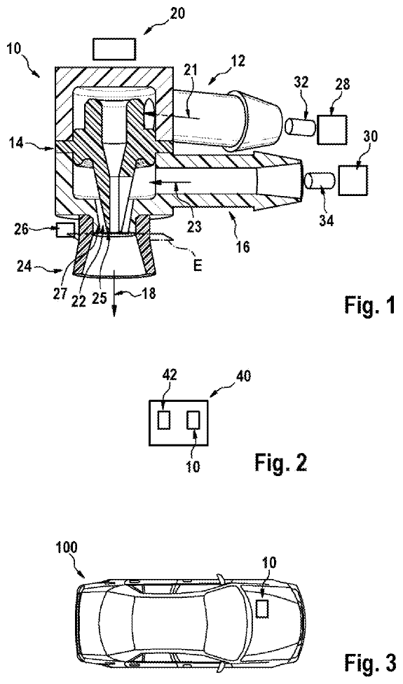

FIG. 1 shows a cleaning system 10. Preferably, the cleaning system 10 comprises a first medium unit 12. Within the first medium unit 12, a first medium flow 21 of a first medium may be configured. The first medium unit 12 may be connected to a pump and/or compressor for the first media unit 28 by means of a first medium line 32. Further, the cleaning system 10 may comprise an acceleration unit 14. The acceleration unit 14 can in particular be connected to the first medium unit 12 in a medium-conducting manner.

Further, the cleaning system 10 preferably comprises a second medium unit 16. The second medium unit 16 may comprise a channel which forms a second medium flow 23 of the second medium. The second medium unit 16 may be connected to a second medium line 34 connecting the second medium unit 16 to a compressor and/or pump for the second medium unit 30. Further, the acceleration unit 14 may form a predetermined fluid flow 18 with the first medium. Further, the second medium unit 16 may blow in and/or introduce the second medium into the predetermined fluid flow 18.

Further, the acceleration unit 14 may have a first tear-off edge 25. Preferably, the second medium unit 16 may have a second tear-off edge 27. Preferably, the first tear-off edge 25 and the second tear-off edge 27 may be arranged in a plane E, as exemplarily shown in FIG. 1. Preferably, the media flows 21 and 23 of the first and second medium are arranged substantially orthogonally to the predetermined fluid flow 18 as shown in FIG. 1.

Preferably, the cleaning system 10 comprises a nozzle unit 24. The nozzle unit 24 may define an orientation of the predetermined fluid flow 18. Further, the nozzle unit 24 may have an actuator 26, which may adjust the orientation of the predetermined fluid flow 18.

Further, the cleaning system 10 may include a control unit 20. The control unit 20 is configured to control the media flow 21 of the first medium and the media flow 23 of the second medium. In particular, the control unit 20 may control the media flows 21, 23 in a predetermined switching sequence.

FIG. 2 shows a wiper system 40 according to one embodiment. The wiper system 40 may include a wiper unit 42. The wiper unit 42 can be configured as a wiper or the like for a windscreen, sensors such as lidar, and/or camera sensors, mirrors, and/or headlights. Further, the wiper system 40 may comprise at least one cleaning system 10 as described above and below.

FIG. 3 shows a vehicle 100 according to one embodiment. Preferably, the vehicle 100 comprises at least one cleaning system 10 as described above and below.

1. A cleaning system (10) of a vehicle (100), comprising:
a first medium unit (12),
an acceleration unit (14),
a second medium unit (16),
wherein the first medium unit (12) is configured to direct a first medium, in particular a cleaning agent, into the acceleration unit (14),
wherein the acceleration unit (14) is configured to discharge the first medium from the cleaning system (10) in a predetermined fluid stream (18), and
wherein the second medium unit (16) is configured to introduce a second medium, in particular a pressurized gas, into the predetermined fluid flow (18).

2. The cleaning system according to claim 1, wherein the cleaning system (10) comprises a control unit (20), wherein the control unit (20) is configured to control a flow of media (21) of the first medium and a flow of media (23) of the second medium.

3. The cleaning system according to claim 2 wherein the control unit (20) is configured to control the flow of media (21) of the first medium and the flow of media (23) of the second medium.

4. The cleaning system according to claim 3, wherein the switching sequence comprises a simultaneous medium flow of the first medium and the second medium followed by a single medium flow (23) of the second medium or the first medium (21).

5. The cleaning system according to claim 2, wherein the control unit (20) is configured to control a pressure and/or a flow rate of the first medium and/or the second medium.

6. A cleaning system according to claim 2, wherein the control unit (20) is configured to set a quantity ratio between the first medium and the second medium.

7. The cleaning system according to claim 1, wherein the medium flow (21) of the first medium passes through the first medium unit (12) and the medium flow (23) of the second medium passes through the second medium unit (16), wherein the medium flow (21) of the first medium and the medium flow (23) of the second medium are arranged substantially orthogonal to a flow direction of the predetermined fluid flow (18).

8. The cleaning system according to claim 1, wherein a gap (22) is arranged between the acceleration unit (14) and the second medium unit (16), wherein the second medium unit (16) directs the second medium through the gap (22) to increase a flow rate of the first medium.

9. The cleaning system according to claim 1, wherein the acceleration unit (14) comprises a first tear-off edge (25), wherein the second medium unit (16) comprises a second tear-off edge (27), wherein the first tear-off edge (25) and the second tear-off edge (27) lie substantially in one plane (E).

10. The cleaning system according to claim 1, wherein the cleaning system (10) comprises a nozzle unit (24), wherein the nozzle unit (24) is configured to atomize the predetermined fluid flow.

11. The cleaning system according to claim 8, wherein the nozzle unit (24) comprises at least one actuator (26), wherein the actuator (26) is configured to alter an orientation of the predetermined fluid flow (18).

12. The cleaning system according to claim 1, wherein the first medium unit (12), the acceleration unit (14), and the second medium unit (16) have a one piece or multi-part design.

13. The cleaning system according to claim 1, wherein the cleaning system (10) comprises at least one pump (28) and/or at least one compressor (30), wherein the pump (28) and/or the compressor (30) are configured to compress the first medium and/or the second medium.

14. The wiper system (40) comprising a wiper unit (42) for windshields, sensors, in particular lidar and/or camera sensors, mirrors and/or headlights, and at least one cleaning system (10) according to claim 1.

15. A vehicle (100) comprising at least one cleaning system (10) according to claim 1.
